(19) United States
(12) Patent Application Publication
(10) Pub. No.: US 2022/0335313 A1
(43) Pub. Date: Oct. 20, 2022

(54) Impact Score Based Target Action Assignment

(71) Applicant: Aible Inc., Foster City, CA (US)

(72) Inventors: Arijit Sengupta, San Francisco, CA (US); Jonathan Wray, San Francisco, CA (US)

(21) Appl. No.: 17/232,667

(22) Filed: Apr. 16, 2021

(51) Int. Cl. G06N 5/04; G06N 20/00

(52) U.S. Cl. CPC G06N 5/04; G06N 20/00

(57) ABSTRACT

Data is received characterizing input attributes associated with a plurality of entities and a target action. A first class associated with a first entity of the plurality of entities is determined by a first submodel of a plurality of submodels. A first plurality of weighted attributes associated with the first entity is determined. A first impact function associated with the first entity is determined based on the first entity. The first impact score associated with the first entity is calculated by the determined first impact function. The calculation can be based on one or more of the first plurality of weighted attributes, the input attributes, and/or a type associated with the target action. The first impact score is indicative of a probability that the first entity will successfully perform the target action. Related apparatus, systems, articles, and techniques are also described.

### TECHNICAL FIELD

The subject matter described herein relates to allocating a target action based on calculation of an impact scores.

### BACKGROUND

In predictive analytics, predictive modeling can include creating, testing, validating, and evaluating a model to best predict the probability of an outcome. The techniques used for predictive modeling can be derived from applications of, for example, machine learning, artificial intelligence, and statistics. Typically, a model can be chosen based on how well it performs in testing, validation, and evaluation. However, a model that tests, validates, and evaluates well on some training data may underperform under different circumstances.

### SUMMARY

In an aspect, data is received characterizing input attributes associated with a plurality of entities and a target action. A first class associated with a first entity of the plurality of entities is determined by a first submodel of a plurality of submodels. The first class is indicative of calculation of a first impact score of the target action. A first plurality of weighted attributes associated with the first entity is determined. A first impact function associated with the first entity is determined based on the first entity. The first impact score associated with the first entity is calculated by the determined first impact function. The calculation can be based on one or more of the first plurality of weighted attributes, the input attributes, and/or a type associated with the target action. The first impact score is indicative of a probability that the first entity will successfully perform the target action.

One or more of the following features can be included in any feasible combination. For example, determining the first impact function can include: accessing, using an identity of the first entity, the first impact function from a table of impact functions; determining, using the first plurality of weighted attributes, a value of a true positive, a value of a true negative, a value of a false positive, and/or a value of a false negative; or weighting, using the first plurality of weighted attributes, the value of the true positive, the value of the true negative, the value of the false positive, and/or the value of the first negative.

A second impact score associated with a second entity of the plurality of entities can be calculated by a second impact function. The calculation can be based on one or more of a second plurality of weighted attributes, the input attributes, and/or the type associated with the target action. The second impact score can be indicative of a probability that the second entity will successfully perform the target action. The first impact score can be compared with the second impact score. The target action can be assigned to the first entity or the second entity based on the comparison between the first impact score and the second impact score. The first class associated with the second entity can be determined. The first class can be indicative of calculation of the second impact score and the second plurality of weighted attributes. The second impact function can be determined based on the second plurality of weighted attributes.

The first submodel and the second submodel can be trained using the received data characterizing input attributes. A first performance of the first submodel can be determined based on output of the first submodel when the first set of input attributes is provided as input to the first submodel. A second performance of the second submodel can be determined based on output of the second submodel when the first subset of input attributes is provided as input to the second submodel. The first subset of input attributes can include one or more of personal information associated with the first entity, performance history of the first entity, and a confidence metric associated with the performance history. The performance history can include one or more of opportunities per year, average opportunity profit, win probability and expected profit. Personal information associated with the first entity can be received from a user.

Activity by the plurality of entities can be monitored over time. The input attributes associated with the plurality of entities can be determined based on the monitoring. The determined input attributes can be stored within a database. Data can be received characterizing a first capacity of the first entity. The first submodel can be selected from the plurality of submodels based on the first capacity. The selected first submodel can be for use to determine the first plurality of weighted attributes. The first capacity can be determined by at least: monitoring historical activity of the first entity and predicting the first capacity based on the monitored historical activity; or monitoring a future schedule of the first entity and predicting the first capacity based on the monitored schedule.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a flowchart illustrating an exemplary method for calculating an impact score indicative of a prediction associated with a target action;

FIG. 2 is a diagram illustrating an example implementation of calculation of impact factors for two subsets on input attributes;

FIG. 3 is a diagram illustrating an example visual representation of a routing rule used to select a submodel associated with a condition of a variable; and

FIG. 4 is a system block diagram according to some example implementations of the current subject matter.

Like reference symbols in the various drawings indicate like elements.

### DETAILED DESCRIPTION

A model (e.g., an efficient frontier) can be trained to perform predictions on a dataset with a wide range of input attributes associated with multiple entities. In some implementations, the model can include multiple submodels where the various submodels are trained, assessed and deployed to provide improved (e.g., optimized, accurate, and the like) prediction for the different subsets of the dataset for achieving a target action (e.g., performing a target function, achieving a target value, and the like). For example, a first submodel and a second submodel can be generated by training the model to provide improved prediction for a first subset and a second subset of input attributes, respectively (e.g., trained for a given target action). A change in the target action may require retraining the submodels for an accurate prediction. But training, assessing, and deploying multiple submodels for a new target action can be cumbersome and inefficient. As such, it can be desirable to allow for prediction without having to retrain the submodels when the target action (e.g., a target value) changes. In some implementations, this can be achieved by deploying an impact function that can calculate an impact score for the various subsets of input attributes and the target action. The impact score can be indicative of a prediction for achieving the target action for the various subsets of input attributes. Based on the impact scores, the target action can be assigned to one or more entities.

In some implementations, the impact function can include a function that enables determining the effect or impact of a decision (e.g., made by a predictive model) on a business organization. For example, an impact function and associated score can be used to assess the effect of a decision on business growth, profit, revenue, and resource utilization. Some example impact functions can characterize maximizing profits for a business, maximizing growth for the business, maximizing revenue for the business, and/or minimizing resource consumption for the business. For example, an impact function can be considered as the sum of the count or probability of true positive, true negative, false positive, and false negative occurrences multiplied by their respective value (or cost where the value is negative).

In some implementations, the impact function can vary based on the entity that will be performing the target action. Consider, for example, a scenario where a decision is made within a sales organization regarding whether or not to pursue a sale lead and which sales team member should pursue the lead. While a model can be trained to determine which team member to assign the work in order to improve a business metric, that model would have to be retrained on a regular basis to account for changes in the business and team environment. For example, a first sales team member may be relatively inexperienced as compared to a second sales team member when the model is initially trained (and therefore the second sales team member is likely to produce a higher return from the lead), but as the first sales team gains experience (and the difference in likely return between the first team member pursuing the lead and the second team member pursuing the lead is reduced), the model would have to be retrained in order to capture the change in experience.

Rather than retraining the model, some implementations of the current subject matter can account for entity specific attributes by selecting an impact function based on the entity. In some implementations, the impact function can, for example, be variable based on attributes associated with the entity and the target action. In the example where the impact function can be considered as the sum of the count or probability of true positive, true negative, false positive, and false negative occurrences multiplied by their respective value (or cost where the value is negative), then the respective values can be determined as a function of the input attributes or can be weighted by weight attributes, which can be specific to the entity.

Although in certain examples described herein the entities are individuals, the entity can be composed of multiple people, such as teams, organizations, and the like.

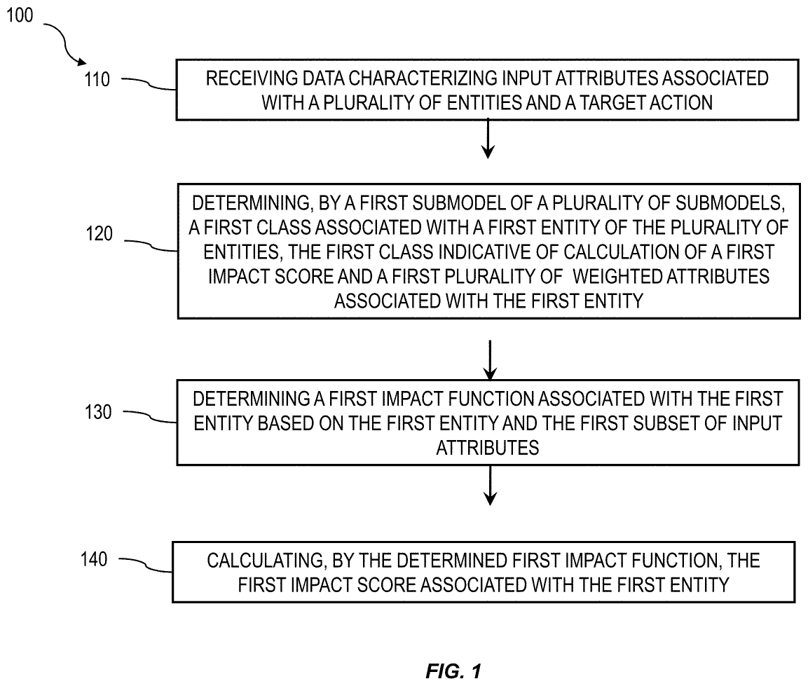

FIG. 1 is a flowchart illustrating an exemplary method for calculating an impact score indicative of a prediction associated with a target action. At step 110, data characterizing input attributes associated with a plurality of entities and a target action can be received. A first subset of input attributes for a first entity of the plurality entities can be routed to a submodel of model (or efficient frontier) including a plurality of submodels. The routing of the first subset of input attributes can be based on routing rules that can select the submodel from the plurality of submodels based on a characteristic property of the first subset of input attributes (e.g., a characteristic value associated with the first subset of input attribute). For example, the selected submodel may have been trained and deployed for performing predictive tasks on a predetermined range of input values that include the characteristic value of the first subset of input attributes.

In some implementations, the submodel that offers best performance for the first subset of input attributes can be selected from a predetermined set of submodels. Alternately, the submodel can be trained to provide desirable performance for the first subset of input attributes (e.g., trained on the entire dataset of input attributes). After one or more submodels have been selected (or trained) for corresponding characteristic values, routing rules can be applied to direct the subsets to input attributes to the best performing submodel. An exemplary routing rule used to select the submodel for an input attribute, such as described in U.S. patent application Ser. No. 16/512,647, filed Jul. 16, 2019, the entire contents of which is hereby incorporated by reference herein.

In some cases, the dataset with the plurality of input attributes can be received, for example, from a graphical user interface. The dataset Dₙ can include input attributes (e.g., records, data entries, and/or the like) for a plurality of entities (e.g., individuals). For example, Dₙ={x⁽¹⁾, . . . , x⁽ⁿ⁾}, where x^{(j)}, j=1, . . . , n, is a subset of input attributes for a j^{th} entity. Each subset of input attributes x^{(j)}, j=1, . . . , n, can include a d-dimensional vector (e.g., for various properties of the j^{th} entity). For example, x^{(j)}=(x₁^{(j)}, . . . , x_{d}^{(j)}) where xₕ^{(j)}, h=1, . . . , d, can be indicative of values of an j^{th} property of the j^{th} entity. In some implementations, each subset of input attributes x^{(j)} can include a characteristic property (e.g., a characteristic property value, a characteristic property vector xₕ^{(j)}, etc.) based on which the subset of input attributes can be routed to a submodel (e.g., based on routing rules). The determination and execution of routing rules is described in U.S. patent application Ser. No. 15/519,127, filed Oct. 31, 2019, the entire contents of which is hereby incorporated by reference herein.

At step 120, a first submodel of a plurality of submodels can determine a first class associated with a first entity of the plurality of entities. The first submodel can receive the first subset of input attributes and the target action as inputs. The first submodel can make a determination whether a prediction for the first entity will be made or not. For example, the first submodel can output a first value that indicates that a prediction will be made (or provides permission for prediction for the first entity), and the first entity can be classified as a first class. For example, using the above described example where the entities are members of a sales team, and the target action is a sales lead, then the first submodel can determine, for the first team member, whether or not to pursue the sales lead (e.g., the classes being “pursue” and “do not pursue”). Alternately, the first submodel can output a second value that indicates that the prediction for the first entity will not be made, and the first entity will be classified as a second class. More than two classes are possible.

In some implementations, the first submodel can calculate a first plurality of weighted attributes associated with the first entity. The weighted attributes can relate to cost-benefit variables specific to the first entity. These attributes can be used to calculate an entity specific impact function and score. The first plurality of weighted attributes can be indicative of properties of the first set of input attributes based on which the first impact score of the first entity can be calculated. In some implementations, the first plurality of weighted attributes can be the first set of input attributes. In some implementations, the first plurality of weighted attributes can be determined by accessing a database specifying weights specific for each of a number of different entities, including the first entity. In some implementations, the first plurality of weighted attributes can be provided by a user (e.g., input by a user into a graphical user interface).

At step 130, a first impact function associated with the first entity can be determined. The determination of the first impact function can based on the first subset of input attributes. In some implementations, the impact function can be determined by at least selecting one of a number of predefined impact functions, the selecting based on the first entity. For example, a first impact function can be selected for a first entity and a second impact function can be selected for a second entity. In some implementations, the impact function can be determined at least by providing the weights into a predefined function that includes parameters (e.g., f(x,w), where w is the weights and x is the inputs). In some implementations, the impact function can, for example, be variable based on attributes associated with the entity and the target action. In the example where the impact function can be considered as the sum of the count or probability of true positive, true negative, false positive, and false negative occurrences multiplied by their respective value (or cost where the value is negative), then the respective values can be determined as a function of the input attributes or can be weighted by the weighted attributes, which can be specific to the entity.

At step 140, the first impact score associated with the first entity can be calculated by the first impact function. In one implementation, the first impact function can receive the target action and the first plurality of weighted attributes as inputs. Based on these inputs, the first impact function can calculate the first impact score.

Considering the example of pursing a sales lead, impact score can be determined from knowing that the first entity has an average margin of 30%, that there is an average cost of sales per opportunity of $3,000, and that the sale opportunity for the first entity is $150,000. The impact of a true positive (e.g., sale completed)=150,000*0.3−3,000=$42,000; False Positive (e.g., sale failed)=−$3,000; True Negative=$0; and False Negative=$0. A different entity may have a different impact function. For example, the sale opportunity, average cost of sales per opportunity and average margin may be specific to the entity.

In some implementations, the first impact function can be provided. For example, providing can include displaying, transmitting, storing, and further processing.

Steps 110-140 can be repeated for a second subset of input attributes associated with a second entity of the plurality of entities. The second subset of input attributes can include a second characteristic property (e.g., a characteristic value, a characteristic vector, etc.). The second subset of input attributes can be routed to a submodel selected from the model based on the second characteristic property. The selection of the submodel (e.g., first submodel, second submodel, etc.) can be achieved by applying the routing rules on the second characteristic property. The selected submodel can be suitable for performing predictive tasks for the second subset of attributes. The selected submodel can determine that the second subset of input attributes is associated with the first class based on the second subset of input attributes and the target action.

The second submodel can make a determination whether a prediction for the second entity will be made or not. For example, the submodel can output the first value that indicates that a prediction will be made (or provides permission for prediction for the second entity), and the second entity can be classified as the first class. Alternately, the submodel can output the second value that indicates that the prediction for the second entity will not be made, and the second entity will be classified as the second class. The submodel can calculate a second plurality of weighted attributes associated with the second entity. The second plurality of weighted attributes can be indicative of properties of the second set of input attributes based on which the second impact score of the second entity can be calculated.

A second impact function can be determined based on the second subset of input attributes (e.g., as describe for the determination of the first impact function above). The second impact score associated with the second entity can be calculated by the second impact function. The second impact function can receive the target action and the second plurality of weighted attributes as inputs. Based on these inputs, the second impact function can calculate the second impact score.

Impact scores can be calculated for the plurality of entities. By comparing the impact scores of the various entities, assignment of the target action can be made. For example, the first and the second impact scores can be used to make the determination whether to assign the target action (e.g., business lead) to the first entity or the second entity. If the first impact score is greater than the second impact score, the determination can be made that the target action will be assigned to the first entity.

Accordingly, some implementations of the current subject matter can offer many technical advantages. In some implementations, the efficient frontier comprising the various submodels may not need to be retrained and redeployed based on a change in the target action and/or change in input attributes of entities (e.g., personal information of the entity, historical performance of the entity, capability of the entity, etc.). Change in the target action and the input attributes can be accounted for by the impact function in the calculation of impact score. The generation and operation of impact functions may be faster and less computationally expensive than retraining the efficient frontier. As such, computational resources, production time, and production costs can be saved. Additionally or alternately, the impact functions can account for updated entity information (e.g., in real-time) that can allow for improved predictions for the entity.

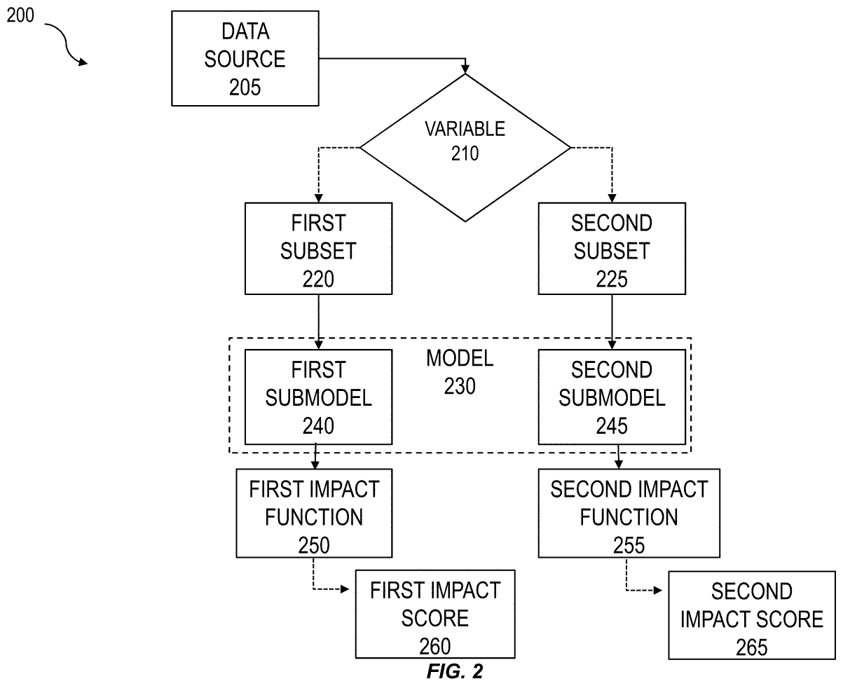

FIG. 2 is a diagram illustrating an example implementation of calculation of impact factors for two subsets on input attributes. By training, assessing, and deploying a single model including a set of submodels with routing rules that direct the specific input attributes (e.g., related to specific entities) to specific submodels and related impact functions, prediction capabilities can be improved (e.g., more efficient due to obviating the need for retraining the submodels for different target actions).

To illustrate routing rules, consider the following example. Data source 205 can include dataset of input attributes characterized by a variable 210 (e.g., a characteristic value, a characteristic vector). In some cases, data source 205 can include the raw data to be scored (e.g., used as input by a model for providing a prediction, a score, and/or the like). The variable conditions can route a subset of data attributes to the correct submodel, the impact score can be calculated, and the impact score can be provided with the user unaware of the path (e.g., the routing rules) taken as the experience can be no different than if using a single model.

The routing rules can route the first subset of input attributes 220 to the first submodel 240 of the model 230. A second subset of input attributes 225 can be routed to a second submodel 245 of the model 230. The routing can be based on the variable 210 in the first and second subset of input attributes: a first value of variable 210 can be routed to the first submodel 240 and a second value of the variable 210 can be routed to the second submodel 245. Additionally, a first impact function 250 (or a second impact function 255) can be generated based on the first subset of input attributes 220 (or second subset of input attributes 225). The first impact function 250 (or second impact function 255) can receive the output of the first submodel 240 (or second submodel 245) and generate a first impact score 260 (or a second impact score 265).

A model including a set of submodels with routing rules can adjust to the strategies, costs, constraints, and/or the like of each entity (e.g., individual) by selecting the model on an efficient frontier that can be suited to each entity. The submodels can be trained with all the input attributes (e.g., sales data), but because the efficient frontier can be defined for any (e.g., regardless of) impact ratio, cost-benefit, constraint, and/or the like, the model including a set of submodels with routing rules can surface the most appropriate leads for each entity (e.g., individual), overcoming the limitations of small datasets for each entity.

Although a few variations have been described in detail above, other modifications or additions are possible. For example, the single model including the set of submodels can be trained using a set of different resourcing levels (e.g., constraints and/or the like) and cost-benefits on the input. In some cases, the single model including the set of submodels can be represented as an ensemble model and can allow for interaction with the set of submodels by interacting with the ensemble model. For example, each submodel in the model can be trained with each of the different resourcing levels on a given input and the performance of each model can be assessed under each of the different resourcing levels.

As described above, routing rules can be generated for the submodels trained with respective resourcing levels. In some cases, the resourcing levels can provide respective conditions on the variables (e.g., specified values of the variables) of the dataset. In some cases, the resourcing levels can provide conditions on the output of the model. For example, the submodels, M={M₁, . . . , Mₖ} (where MᵢϵM is a submodel) can be trained using a set of resourcing levels (e.g., constraints and/or the like), C={c₁, . . . , cₚ} (where cᵢϵC is a constraint). In some cases, the submodels can be represented as an ensemble model. The routing rules can associate the provided conditions (e.g., resourcing levels, constraints, and/or the like) with respectively trained submodels. In response to receiving user input specifying a condition (e.g., resourcing levels, constraints, and/or the like) on the variable, the routing rules can be used to select the submodel associated with the value of the variable specified by the user input.

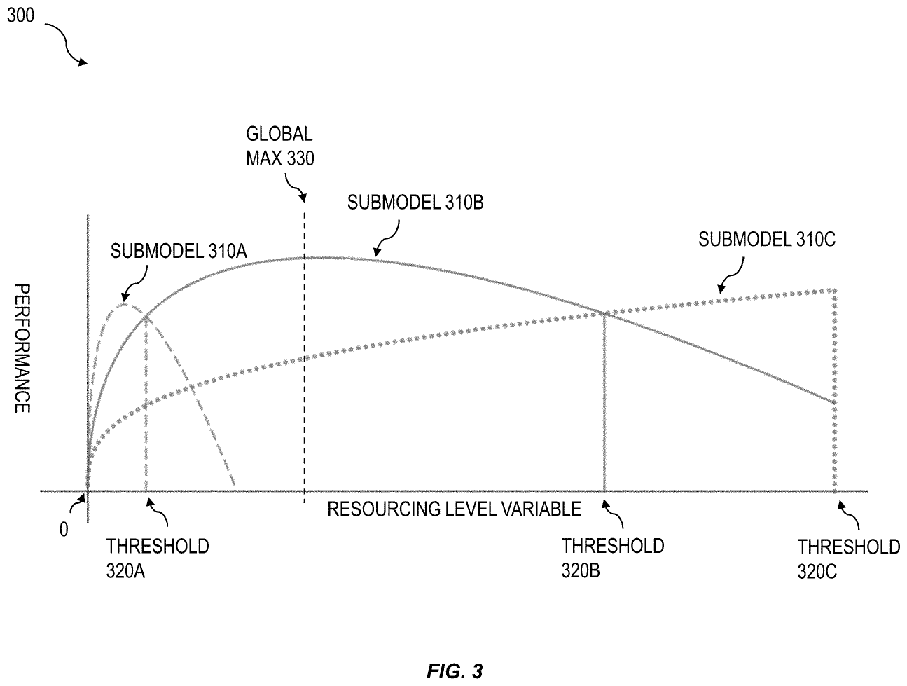

FIG. 3 is a diagram illustrating an example visual representation 300 of an efficient frontier and including a routing rule used to select the submodel associated with a condition of a variable, such as described in U.S. patent application Ser. No. 16/512,647, filed Jul. 16, 2019. In some cases, visual representation 300 can include a feasible performance region including a set of intervals I={(a₁, a₂), . . . , (aₚ₋₁, aₚ)} and, for each interval (aᵢ, aᵢ₊₁), the associated submodel M₍ₐ_{ᵢ}_{,a}_{ᵢ₊₁}₎=Mₗ such that Mₗ can include the optimally performing submodel in the interval (aᵢ, aᵢ₊₁). By training and assessing multiple submodels under different resourcing levels and providing an intuitive representation of the performance of the models under the different constraints, the submodel most appropriate for a given operational constraint can be selected. As such, the performance of the model including the submodels can be improved and computational resources, production time, and production costs can be saved.

The visualization 300 can include, for example, a graph of performance as a function of the resourcing variable. In some cases, performance can include impact. The output of each submodel can be graphed. FIG. 3 illustrates the output of three submodels, submodel 310A, M_{A}, submodel 310B, M_{B}, and submodel 310C, M_{C}. As illustrated in FIG. 3, below threshold 320A the performance of submodel 310A is optimal (e.g., submodel 310A maximizes impact), between threshold 320A and threshold 320B the performance of submodel 310B is optimal, and after threshold 320B the performance of submodel 310C is optimal. The intervals can be defined as I={(a₁, a₂), (a₂, a₃), (a₃, a₄)}, where a₁=0, a₂=threshold 320A, a₃=threshold 320B, a₄=threshold 320C. Then, the feasible performance region can include a correspondence between an interval and an optimal submodel for the respective interval. For example, with reference to FIG. 3, the feasible performance region can include, Feasible Performance Region={(a₁, a₂): M_{A}, (a₂, a₃): M_{B}, (a₃, a₄): M_{C}}. To the user, visualization 300 can represent the performance of the submodels (e.g., M={M_{A}, M_{B}, M_{C}} and/or the like) and the submodels can be treated as a single model.

In one implementation, input attributes (e.g., first/second subset of input attributes) can include one or more of personal information, performance history, and a confidence metric associated with the performance history associated with an entity (e.g., first/second entity). The performance history can include one or more of opportunities per year, average opportunity profit, win probability and expected profit. The performance history can include one or more of opportunities per year, average opportunity profit, win probability and expected profit. The personal information can be received from the entity via a graphical user interface (GUI) display space. In some implementations, activity by the plurality of entities can be monitored over time. Based on the monitored activity, input attributes associated with the plurality of entities can be determined. The determined input attributes can be stored within a database.

In some implementations, data characterizing a first capacity of the first entity can be received, and a first submodel can be selected from the plurality of submodels based on the first capacity. The selected first submodel can be used to determine the first plurality of weighted attributes. In some implementations, determining the first capacity can include monitoring historical activity of the first entity and predicting the first capacity based on the monitored historical activity. Additionally or alternately, determining the first capacity can include monitoring a future schedule of the first entity and predicting the first capacity based on the monitored schedule.

The following includes an example use. In one implementation, prediction can be made for the allocation of a business lead (target action) based on calculation of impact scores. For example, an individual from a plurality of individuals with the highest impact score can be awarded the business lead. Input attributes can be received for multiple individuals. Input attributes for a given individual (also referred to as subset of input attributes) can include, for example, average opportunity profit, capacity (e.g., opportunity per year), win probability, expected profit, etc. In one implementation, a subset of input attributes can be in the form of a column vector assigned to the given individual in a dataset (e.g., column vector x^{(j)} in a dataset Dₙ={x⁽¹⁾, . . . , x⁽ⁿ⁾} comprising input attributes of multiple individuals).

Each individual can be assigned a submodel (e.g., based on routing rules) from a plurality of submodels (e.g., in an efficient frontier). The submodel can be selected from an existing set of submodels, or can be trained based on the received input attributes. The submodels can determine whether or not to pursue the business lead, for example, the submodels can return a “pursue lead” or “don't pursue lead” for each individual on a sales team (e.g., first individual and second individual). For a given “pursue lead” output from a submodel, an impact function can be determined for the corresponding individual (e.g., based on the entire dataset with attributes of all the individuals). In some implementations, the submodel can also generate a plurality of weighted attributes (e.g., corresponding to “lead type”) for the individual. The lead type can be indicative of individual's proficiency in various business areas (e.g., automotive, enterprise, consumer, etc.). The lead type can be used to determine the individual's probability of success in pursing the business lead.

The determined impact function can calculate the impact score of the individual based on the lead type associated with the individual. For example, when computing impact for a first individual who has great success at automotive leads, the impact score would be weighted, e.g., 0.5 for “automotive” type, 0.25 for “enterprise” type, and 0.25 for “consumer” type. A second individual may have an impact score weighted as 0.33 “auto”, 0.33 “enterprise”, and 0.33 “consumer”. The individual with the highest impact score for the business lead would be allowed to pursue the lead.

Additionally or alternatively, the impact function can calculate the impact score based on one or more of personal information of the individual, performance history of the individual, and confidence metric associated with the performance history. Personal information can include, for example, calendar of the individual that can indicate if the individual is unavailable to pursue the business lead (e.g., individual is on a vacation when the business lead needs to be pursued), individual is partially available/working at a lower capacity to pursue the business lead (e.g., the individual is travelling and can intermittently work on pursuing the lead, individual has other assignments such as other business leads), and the like. Performance history can include, for example, previous business leads pursued by the individual, performance assessment of the individual, individual's experience with similar business leads, and the like. The confidence metric can be an indicator of the performance of the individual in the past (e.g., based on performance history over a predetermined period). The confidence metric can include, for example, a performance metric that can be used to weight the impact score. The confidence metric can be used, for example, where there is limited historical data regarding an entities historical performance. The confidence metric allows for a user (e.g., a manager) to provide a manual weighting to the impact function. In some implementations, a confidence interval can be applied to the confidence metric (e.g., a confidence in the manually provided confidence metric).

Personal information of the individual can be obtained directly from the individual (e.g., via a user input through a GUI display space), form a human resource database, electronic calendar of the individual, and the like. For example, the individual can provide information associated with his/her capacity to pursue the business lead in given time period (e.g., predetermined time period in the future).

In some implementations, a monitoring system can track information (e.g., personal information, personal history, assigned impact scores) of an individual (based on assignment of a unique identification (ID)) with the performance of the individual. For example, for a given individual, the monitoring system can track assigned impact scores for business leads (e.g., indicative of prediction) and outcomes of the pursuit of the business leads. The outcomes can include performance of the individual in pursuing the business leads, successful completion of the pursuit of the business leads (e.g., indicated by a completion status flag), and the like. Additionally or alternately, the outcomes can be tracked as a function of the person's capacity when the business leads were pursued.

Through the aforementioned monitoring, performance of the efficient frontier and/or impact functions can determined (e.g., the model is overestimating or underestimating the individual's ability to succeed/individual's capacity, etc.). The monitoring can be indicative of the performance of the model (e.g., overestimation/underestimation of individual's performance). Additionally or alternately, monitoring can indicate that an individual has high capacity but is failing to perform at a desirable level. This information can be used on the future determination of impact scores (e.g. can be an input in the impact function).

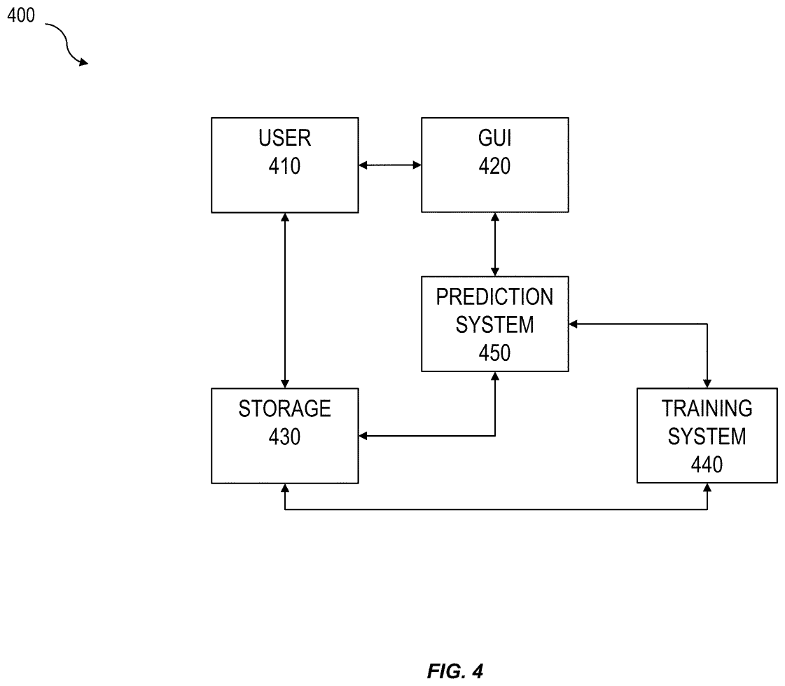

FIG. 4 is a system block diagram illustrating an example implementation of a system 400 for training, assessing, and deploying a set of resourcing models. System 400 can include graphical user interface (GUI) 420, storage 430, training system 440, and prediction system 450. GUI 320 can be configured to receive input from user 310. For example, the input can include a dataset Dₙ={x⁽¹⁾, . . . , x⁽ⁿ⁾} for training the set of models M={M₁, . . . , Mₖ}, where k is the number of models in the set of models. As another example, the input can include values TPᵥ, TNᵥ, FPᵥ, FNᵥ; counts TP_{c}, TN_{c}, FP_{c}, FN_{c}; and/or the like. As another example, the input can include constraints (e.g., a condition on a variable and/or the like) c_{h,r}^{(j)} on variables xₕ^{(j)} (e.g., columns and/or the like) of elements x^{(j)} (e.g., rows and/or the like) of the dataset Dₙ, where, for example, xₕ^{(j)} ϵx^{(j)}=(x₁^{(j)}, xₕ^{(j)}), . . . , x_{d}^{(j)}), x^{(j)} ϵDₙ, where n is the number of entries (e.g., rows and/or the like) in the dataset, d is the dimension (e.g., number of columns and/or the like) of each dataset entry, j is an index indicating a value in the range {1, . . . , n} (e.g., an index pointing to a dataset entry and/or the like), h is an index indicating a value in the range {1, . . . , d} (e.g., an index pointing to a variable of a dataset entry and/or the like), and r is an index indicating a value in the range {1, . . . , number of constraints on the variable xₕ^{(j)}} (e.g., an index pointing to a constraint in the set of constraints on a variable and/or the like.

As another example, GUI 420 can be configured to receive user input specifying a training goal. For example, a training goal can include an indication of the output, performance, and/or the like of the set of models. Storage 430 can be configured to store (e.g., persist and/or the like), for example, inputs received from GUI 320 such as datasets Dₙ={x⁽¹⁾, . . . , x⁽ⁿ⁾}; values TPᵥ,TNᵥ,FPᵥ,FNᵥ; counts TP_{c}, TN_{c}, FP_{c}, FN_{c}; constraints c_{h,r}^{(j)} on variables xₕ^{(j)}; and/or the like. As will be discussed below, storage 430 can be configured to store sets of trained models. And storage 430 can be configured to store, for example, the performance of the sets of models, assessments of the performance of the sets of models, and/or the like. Storage 230 can include, for example, repositories of data collected from one or more data sources, such as relational databases, non-relational databases, data warehouses, cloud databases, distributed databases, document stores, graph databases, operational databases, and/or the like.

Training system 440 can be configured to train sets of models M={M₁, . . . , Mₖ} on datasets, such as Dₙ={x⁽¹⁾, . . . , x⁽ⁿ⁾}. Each model Mᵢ ϵM can be trained on the entries x^{(j)} in the dataset Dₙ using, for example, learning algorithms, such as principal component analysis, singular value decomposition, least squares and polynomial fitting, k-means clustering, logistic regression, support vector machines, neural networks, conditional random fields, decision trees, and/or the like. In some cases, the sets of models can be trained on constrained variables xₕ^{(j)} ϵx^{(j)}, where x^{(j)} ϵDₙ and the constraint includes c_{h,r}^{(j)}. In some cases, user input can be received specifying a new constraint value c_{h,r+1}^{(j)} and a new model Mₖ₊₁ can be generated. For example, the new model Mₖ₊₁ can be trained on the new constraint c_{h,r+1}^{(j)}.

Prediction system 450 can be configured to assess the performance of sets of models, such as M={M₁, . . . , Mₖ}, and determine feasible performance regions. The feasible performance region can include a set of intervals I={(a₁, a₂), . . . , (aₚ₋₁, aₚ)}, where for a given interval (a₁, aᵢ₊₁)ϵI, a₁ϵ{a₁, . . . , aₚ₋₁} can include the start values of the intervals and aᵢ₊₁ϵ{a₂, . . . , aₚ} can include the end values of the intervals, such that for each interval (aᵢ, aᵢ₊₁)ϵI, a model M₍ₐ_{ᵢ}_{,a}_{ᵢ₊₁}₎ ϵM can provide optimal performance in the given interval (aᵢ, aᵢ₊₁). The optimally performing model M₍ₐ_{ᵢ}_{,a}_{ᵢ₊₁}₎, for example, can be associated with and used for values of the variable within the interval (e.g., xₕ^{(j)}ϵ(aᵢ, aᵢ₊₁) and/or the like).

Following the above example, for each data set entry x^{(j)} ϵDₙ and for each value of a variable in each dataset entry (e.g., xₕ^{(j)}ϵx^{(j)}), such that a₁≤xₕ^{(j)}≤aₚ, the performance of each model Mₗ ϵM can be assessed by determining the output of each model Mₗ when given the variable xₕ^{(j)}, (e.g., Mₗ (xₕ^{(j)}) can be computed and/or the like). In some cases, the output of the model can include impact. After computing the output of each model Mₗ ϵM over the values of the variable xₕ^{(j)} in each interval (aᵢ, aᵢ₊₁) ϵI, the feasible performance region can include the set of intervals I={(a₁, a₂), . . . , (aₚ₋₁, aₚ)} and, for each interval (aᵢ, aᵢ₊₁), the associated model M₍ₐ_{ᵢ}_{,a}_{ᵢ₊ᵢ}₎=Mₗ such that Mₗ can include the optimally performing model in the interval (aᵢ, aᵢ₊₁). For example, the feasible performance region can include a map of intervals (aᵢ, aᵢ₊ᵢ) to models M₍ₐ_{ᵢ}_{,a}_{ᵢ₊₁}₎, such that Feasible Performance Region={(a₁, a₂): M₍ₐ_{₁}_{,a}_{₂}₎, . . . , (aₚ₋₁, aₚ): M₍ₐ_{ₚ₋₁}_{,a}_{ₚ}₎}.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
receiving data characterizing input attributes associated with a plurality of entities and a target action;
determining, by a first submodel of a plurality of submodels, a first class associated with a first entity of the plurality of entities, the first class indicative of calculation of a first impact score of the target action;
determining a first plurality of weighted attributes associated with the first entity;
determining a first impact function associated with the first entity based on the first entity; and
calculating, by the determined first impact function, the first impact score associated with the first entity, wherein the calculation is based on one or more of the first plurality of weighted attributes, the input attributes, and/or a type associated with the target action, wherein the first impact score is indicative of a probability that the first entity will successfully perform the target action.

2. The method of claim 1, wherein determining the first impact function includes:
accessing, using an identity of the first entity, the first impact function from a table of impact functions;
determining, using the first plurality of weighted attributes, a value of a true positive, a value of a true negative, a value of a false positive, and/or a value of a false negative; or
weighting, using the first plurality of weighted attributes, the value of the true positive, the value of the true negative, the value of the false positive, and/or the value of the first negative.

3. The method of claim 1, further comprising:
calculating, by a second impact function, a second impact score associated with a second entity of the plurality of entities, wherein the calculation is based on one or more of a second plurality of weighted attributes, the input attributes, and/or the type associated with the target action, wherein the second impact score is indicative of a probability that the second entity will successfully perform the target action;
comparing the first impact score with the second impact score; and
assigning the target action to the first entity or the second entity based on the comparison between the first impact score and the second impact score.

4. The method of claim 3, further comprising:
determining the first class associated with the second entity, the first class indicative of calculation of the second impact score and the second plurality of weighted attributes; and
determining the second impact function based on the second plurality of weighted attributes.

5. The method of claim 3, further comprising:
training, using the received data characterizing input attributes, the first submodel and the second submodel;
determining a first performance of the first submodel based on output of the first submodel when the first set of input attributes is provided as input to the first submodel; and
determining a second performance of the second submodel based on output of the second submodel when the first subset of input attributes is provided as input to the second submodel.

6. The method of claim 1, wherein the first subset of input attributes include one or more of personal information associated with the first entity, performance history of the first entity, and a confidence metric associated with the performance history,
wherein the performance history includes one or more of opportunities per year, average opportunity profit, win probability and expected profit.

7. The method of claim 6, further comprising receiving personal information associated with the first entity from a user.

8. The method of claim 1, further comprising:
monitoring activity by the plurality of entities, the monitoring over time;
determining, based on the monitoring, the input attributes associated with the plurality of entities; and
storing, within a database, the determined input attributes.

9. The method of claim 1, further comprising:
receiving data characterizing a first capacity of the first entity; and
selecting the first submodel from the plurality of submodels based on the first capacity, wherein the selected first submodel is for use to determine the first plurality of weighted attributes.

10. The method of claim 9, further comprising determining the first capacity by at least:
monitoring historical activity of the first entity and predicting the first capacity based on the monitored historical activity; or
monitoring a future schedule of the first entity and predicting the first capacity based on the monitored schedule.

11. A system comprising:
at least one data processor; and
memory storing instructions which, when executed by the at least one data processor, causes the at least one data processor to perform operations comprising:
receiving data characterizing input attributes associated with a plurality of entities and a target action;
determining, by a first submodel of a plurality of submodels, a first class associated with a first entity of the plurality of entities, the first class indicative of calculation of a first impact score of the target action;
determining a first plurality of weighted attributes associated with the first entity;
determining a first impact function associated with the first entity based on the first entity; and
calculating, by the determined first impact function, the first impact score associated with the first entity, wherein the calculation is based on one or more of the first plurality of weighted attributes, the input attributes, and/or a type associated with the target action, wherein the first impact score is indicative of a probability that the first entity will successfully perform the target action.

12. The system of claim 11, wherein determining the first impact function includes:
accessing, using an identity of the first entity, the first impact function from a table of impact functions;
determining, using the first plurality of weighted attributes, a value of a true positive, a value of a true negative, a value of a false positive, and/or a value of a false negative; or
weighting, using the first plurality of weighted attributes, the value of the true positive, the value of the true negative, the value of the false positive, and/or the value of the first negative.

13. The system of claim 11, the operations further comprising:
calculating, by a second impact function, a second impact score associated with a second entity of the plurality of entities, wherein the calculation is based on one or more of a second plurality of weighted attributes, the input attributes, and/or the type associated with the target action, wherein the second impact score is indicative of a probability that the second entity will successfully perform the target action;
comparing the first impact score with the second impact score; and
assigning the target action to the first entity or the second entity based on the comparison between the first impact score and the second impact score.

14. The system of claim 13, the operations further comprising:
determining the first class associated with the second entity, the first class indicative of calculation of the second impact score and the second plurality of weighted attributes; and
determining the second impact function based on the second plurality of weighted attributes.

15. The system of claim 13, the operations further comprising:
training, using the received data characterizing input attributes, the first submodel and the second submodel;
determining a first performance of the first submodel based on output of the first submodel when the first set of input attributes is provided as input to the first submodel; and
determining a second performance of the second submodel based on output of the second submodel when the first subset of input attributes is provided as input to the second submodel.

16. The system of claim 11, wherein the first subset of input attributes include one or more of personal information associated with the first entity, performance history of the first entity, and a confidence metric associated with the performance history,
wherein the performance history includes one or more of opportunities per year, average opportunity profit, win probability and expected profit.

17. The system of claim 16, the operations further comprising receiving personal information associated with the first entity from a user.

18. The system of claim 11, the operations further comprising:
monitoring activity by the plurality of entities, the monitoring over time;
determining, based on the monitoring, the input attributes associated with the plurality of entities; and
storing, within a database, the determined input attributes.

19. The system of claim 11, the operations further comprising:
receiving data characterizing a first capacity of the first entity; and
selecting the first submodel from the plurality of submodels based on the first capacity, wherein the selected first submodel is for use to determine the first plurality of weighted attributes.

20. A non-transitory computer readable medium storing computer executable instructions which, when executed by at least one data processor forming part of at least one computing system, causes the at least one data processor to perform operations comprising:
receiving data characterizing input attributes associated with a plurality of entities and a target action;
determining, by a first submodel of a plurality of submodels, a first class associated with a first entity of the plurality of entities, the first class indicative of calculation of a first impact score of the target action;
determining a first plurality of weighted attributes associated with the first entity;
determining a first impact function associated with the first entity based on the first entity; and
calculating, by the determined first impact function, the first impact score associated with the first entity, wherein the calculation is based on one or more of the first plurality of weighted attributes, the input attributes, and/or a type associated with the target action, wherein the first impact score is indicative of a probability that the first entity will successfully perform the target action.
